(19) United States
(12) Patent Application Publication
(10) Pub. No.: US 2008/0202008 A1
(43) Pub. Date: Aug. 28, 2008

(54) Fastening Means as Well as Method and Apparatus for This

(76) Inventors: Hakan Asph, Partille (SE); Roger Eghult, Akersberga (SE)

Correspondence Address: HAYES SOLOWAY P.C., 3450 E. SUNRISE DRIVE, SUITE 140, TUCSON, AZ, 85718, US

(21) Appl. No.: 11/994,332

(22) PCT Filed: Jul. 5, 2006
(86) PCT No.: PCT/SE06/00841

§ 371 Date: Dec. 29, 2007

(30) Foreign Application Priority Data
Jul. 8, 2005 (SE) 0501676-1

(51) Int. Cl. G09F 3/14; B29C 65/00; B65C 7/00

(52) U.S. Cl. 40/663; 40/662; 29/700

(57) ABSTRACT

Connection method, in particular for articles for sale that are to be provided with an appended manual, warranty et cetera by means of a plastic tape laid in a lope or coil, the ends of which are welded together, at which a tape, strip or the like (7) is inserted through receiving openings (13) in the objects that are to be connected. The tape (7) is held fast in the inserted end, thereafter the objects (2, 3) that are to be connected are moved in relation to the tape (7) so that the tape receives a more or less U-shaped contour. Thereafter the ends of the tape are brought together and joined.

In order to fasten information about price, material, handling advice, instructions as well as warrants et cetera on objects that are to be sold it is known to use short plastic strings that in both ends are provided with means that can be inserted into each other for durable locking. These devices must however be shaped comparatively exact and therefor become comparatively expensive. Furthermore it has turned out to be comparatively difficult to achieve a reliable apparatus for machine fastening and the work therefor often get a too great manual character to be economically appealing. There is thus need for a fastening of the above type that is lower in cost and more suited for automatzation. This not least in view of the fact that many details sold in this way in themselves have a very low price that in a negative manner is increased by the known fastening means.

The above object is in accordance with the invention solved by the fastening means being constituted by a stretch of plastic strip that is threaded through holes in the parts that are to be connected, whereafter the ends of the plastic strip are welded together. In particular the ends may be placed parallel facing each other before the welding so that a more or less drop like shape is obtained for the fastening means in the fixed state.

Through the use of one simple plastic strip without any special shaping in the ends the cost of the fastening means itself can be kept low since no special shaping has to take place and a low cost plastic material can be used unlike the known devices.

In accordance with the invention the fastening means described above can be fastened to one or several objects by the plastic strip being inserted through a hole in the object or objects, the inserted, so to say front, end of the strip is then held fast on the other side of the object or objects. Hereafter the object or objects that are to be connected are moved laterally a short distance. The other end of the strip, that is the end that has not been inserted down through the objects is brought down against the inserted end of the strip or close to this and in this position the ends of the strip or tape are welded to each other so that the objects are held together.

The above described schematic method to apply the fastening means become due to its simplicity reliable and also adaptable to different kinds of objects and required strip lengths.

Further characteristics of advantageous further developments of the inventive concept are apparent from the patents claims as well as from the following description of an embodiment shown in the enclosed drawings.

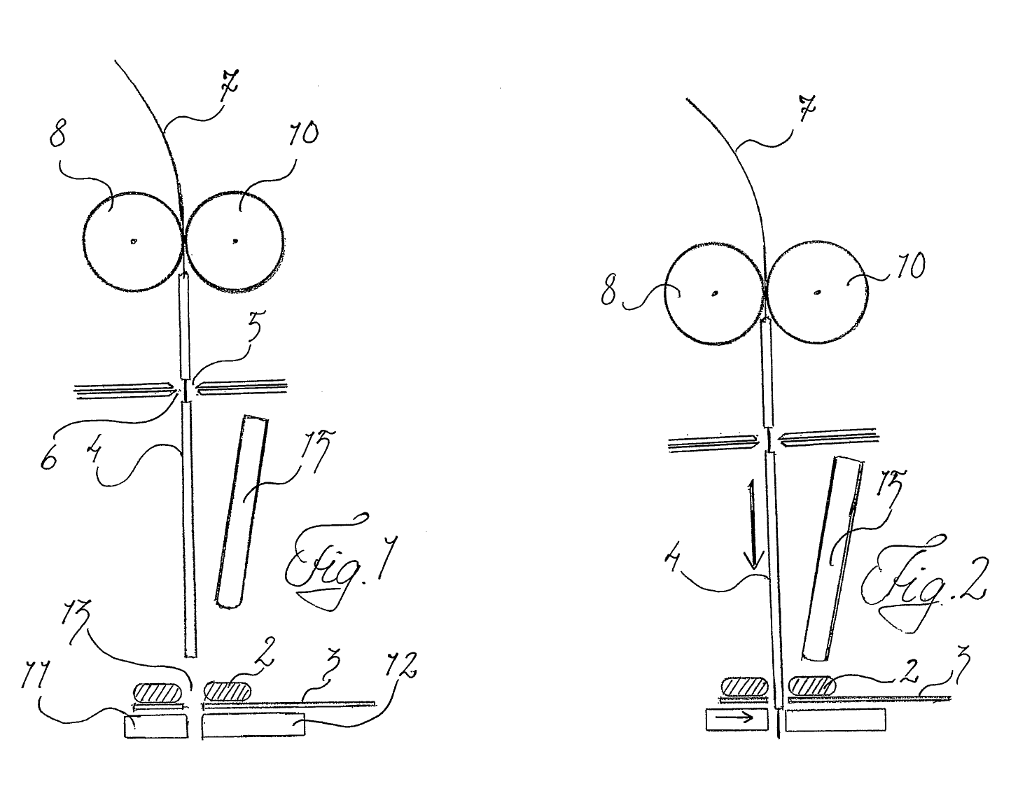

In the drawings FIGS. 1-4 depict different steps in an applying of a fastening means in accordance with the invention and

FIG. 5 an applied fastening means.

The fastening means 1 shown in FIG. 5 comprise only one single plastic strip of weldable material. The plastic strip is inserted through openings in the objects that are to be connected, that is a slice of plastic 2 and a manual 3. The ends of the plastic strip have been put together so that the ends are parallel and directed away from the remaining part of the fastening means and the ends are welded fast to each other.

The fixing station shown schematically in FIG. 1 to 4 for the applying of the fixing means 1 comprise a flat tube 4 with slightly larger internal dimensions than the plastic strip 7. A distance up on the tube a cutting device, in the shape of two panels, is arranged with thorough holes 5 and 6 and were one panel by means of an air cylinder can be displaced so that a cutting of a tape or band 7 present in the tube can take place. Above the tube drive rollers 8, 10 are arranged for the feeding of the tape 7. The tube together with the means for feeding and cutting are moveable up and down.

The mounting devices also have a device, not shown, to bring the objects that are to be fastened together past the above described tube with the openings through which the tape is to be inserted centered in relation to the tube.

Next to the tube a welding device 15 is arranged for instance for welding by means of ultrasonic sound or heat. Below the path of the objects that are to be connected a moveable jaw 11 can be pressed against a fixed jaw 12 for the holding of the lower end of the strip 7. A counter stay for the welding device 15 is integrated in the fixed jaw 12.

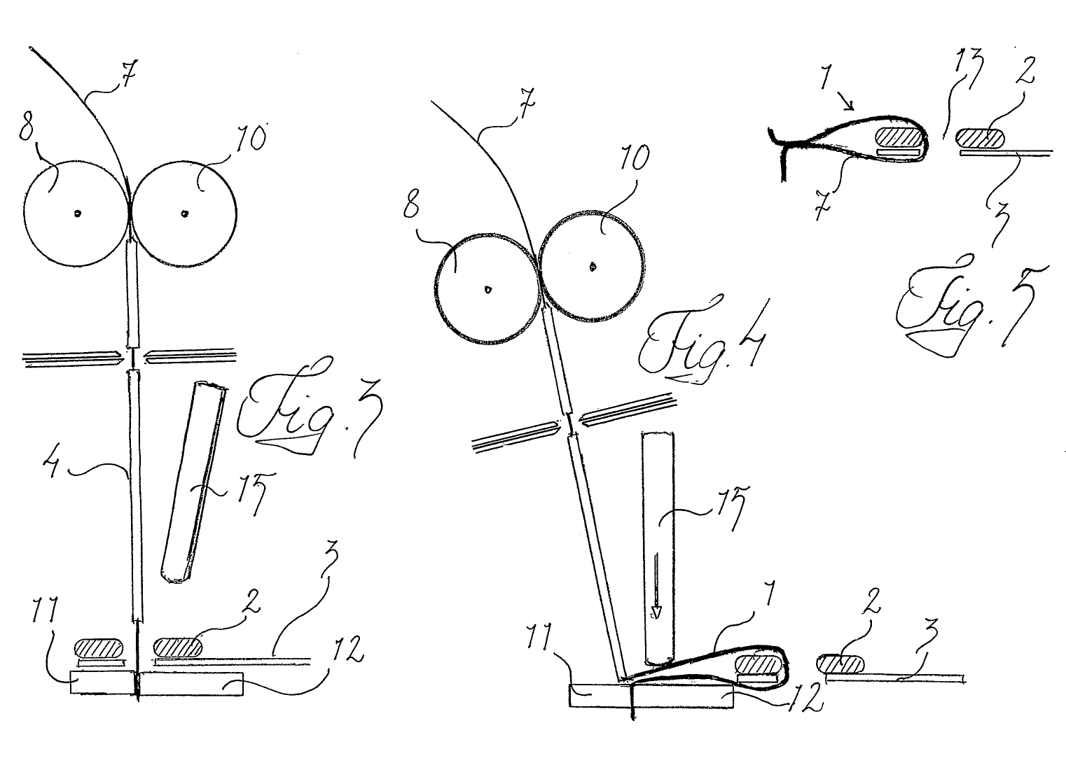

At the applying of the fastening means in accordance with the invention the objects that are to be connected are for instance by means of picking means placed on a conveyor for the transport to the mounting place. For instance the conveyor may have the shape of rotatable table with several reception places for the objects that are to be fastened together and the holding of these to the table can for instance be achieved by sub-pressures. When the openings in the parts that are to be connected to each other are centrally located in relation to the tube and thereby the length direction of the tape 7 the table is stopped (FIG. 1), the tube 4 is lowered together with the tape 7 therein down through the openings 13 in the objects that are to be connected (FIG. 2). The movement downwards is ended when the tube and the tape have been inserted through the objects that are to be connected and tape 7 is fed out between the clamping jaws 11, 12 below the objects 2, 3 that are to be connected, the jaws by means of an air-pressure cylinder gripping the tape FIG. 3. The tube 4 including its drive device 8, 10 is once again lifted up so that the lower end of the tube is located freely above the objects that are to be connected. The objects that are to be connected are now fed forward a short distance (FIG. 4) so that the objects that are to be connected completely pass the tube. The strip 7 that at this is drawn out further from the tube now lie like a lieing U the lower leg of which is clamped between the jaws 11, 12 with its bent out end and in the other leg the tape is bent up through the tube. The tube is moved, swiveled somewhat laterally against the direction of movement for the objects that are to be connected together and the tube is lowered so that it press the upper part of the U-shaped tape against the lower part so that the tape is now held fast. In this position the welding device 15 is lowered down (FIG. 4) by means of a small air pressure cylinder so that the welding device get in contact with a strip 7 and press the parts of this against the counter stay placed below. Heat is provided so that the tape is welded together and thereafter the welding device and tube respectively are mowed upwards and returned to the starting position.

The tube with its feeding and welding device is mounted on a common wall or plate that is pivotable in parallel with the direction of movement (in the mounting position) for the objects that are to be connected to move welding device and tube between the work positions. By the pivoting of the plate for welding the welding device 15 can be located very close to the holding jaws.

The required strip of a tape or band has been cut off shortly after the clamping of the forward end of the tape between the jaws. The friction between tube and tape retains the rear end in the tube until the welding is finished and the tube lifted up. The jaws hold the strip when the tube with accompanying driving and cutting means are lifted sufficiently to allow the tape to become free from the tube.

The forward feeding of the table can be by means of two air pressure cylinders, one for the feeding of the set of parts that are to be connected and a second one for the smaller feeding between the insertion of the tape through the openings in the objects and the welding position.

After the connecting of the objects with the fastening means in accordance with the invention these are removed from the table by means of suitable picking means.

In the shown case the cutting of the tape takes place when the front end of the tape has been gripped by the clamping means below the objects that are to be connected. The cutting may however take place in an arbitrary position during the lifting movement of the tube and it is also possible to conceive the tube being lifted extra high before cutting takes place if a longer tape is required. One can also consider that the objects that are to be connected are moved a short distance before cutting takes place if the strip needs to be longer.

1-8. (canceled)

9. A device for fastening a manual or warranty card to an objects for sale, comprising a plastic tape or band laid in a loop or coil with its ends welded to each other.

10. The device of claim 9, wherein the ends of tape are welded together directed in the same direction so that a drop-like shape is obtained.

11. A method for applying the device of claim 9, wherein a tape, strip or the like is inserted through receiving openings in the object for sale, whereafter the tape is held fast in the inserted end, thereafter the object for sale is displaced in relation to the tape so that the tape receives a more or less U-shaped extension, whereafter the ends of the tape or band are brought together and joined.

12. The method of claim 11, wherein the ends of the tape are put against each other and in the same direction before the joining.

13. The method of claim 11, wherein the tape is cut to a predetermined length before being inserted through the object for sale, and that the end of the tape is held fast on the other side of the object for sale.

14. An apparatus for the execution of the method of claim 11, comprising a tube moveable to be inserted through openings in the object for sale, a clamping device for gripping a tape pushed through by the tube and running in the tube, a device for moving the object, and a welder means for pressing together and welding of the ends of the tape to each other.

15. The apparatus of claim 14, wherein the tube and welder are arranged moveable together in the movement direction of the object so that the weld may be applied close to the clamp.

16. The apparatus according to claim 14, further comprising a cutting device is arranged in the tube for the cutting of the tape or band.
